(19) United States
(12) Patent Application Publication
(10) Pub. No.: US 2010/0112524 A1
(43) Pub. Date: May 6, 2010

(54) Method for producing a functional prosthesis

(76) Inventor: Hans-Ulrich Meier, Oberhausen (DE)

Correspondence Address: DENNISON, SCHULTZ & MACDONALD, 1727 KING STREET, SUITE 105, ALEXANDRIA, VA, 22314, US

(21) Appl. No.: 12/588,925

(22) Filed: Nov. 2, 2009

(30) Foreign Application Priority Data
Oct. 31, 2008 (DE) 10 2008 037 512.8
Dec. 17, 2008 (DE) 10 2008 055 534.7
Feb. 17, 2009 (EP) 09 153 042.8

(51) Int. Cl. A61C 8/00

(52) U.S. Cl. 433/201.1

(57) ABSTRACT

The invention relates to a method for producing a functional prosthesis as a provision for a jaw region, allowing for the procedural steps of taking a dental impression of the jaw region to be provided with the functional prosthesis, producing a preliminary structure and possibly testing the preliminary structure in an articulator, and producing the functional prosthesis on the basis of the possibly re-worked preliminary structure. In order to produce a functional prosthesis by incorporating a preliminary structure, in which a functional analysis of the stomatognathic system can be taken into account, it is proposed that the preliminary structure be manufactured of a markable material with a hardness H that corresponds to 90% to 100% of the hardness of at least one natural or refurbished tooth of an antagonist of the jaw region, that the preliminary structure subsequently be integrated into the jaw region and remain in the jaw region for a wearing period of approximately 5 to 30 day, that the preliminary structure subsequently be removed and thereupon the functional prosthesis be manufactured taking into consideration any changes the preliminary structure underwent during its wearing.

The invention relates to a method for producing a functional prosthesis as a provision for a jaw region, comprising the procedural steps:
taking a dental impression of the jaw region to be provided with the functional prosthesis,
producing a preliminary structure and possibly testing the preliminary structure in an articulator, and
producing the functional prosthesis on the basis of the possibly re-worked preliminary structure.

Functional diagnostics for function-based prosthetics are often neglected in dentistry, even though they deserve special attention. As is well known, the relative position of the jaws is subject to various influences and great changes during a lifetime. For example, once a patient has lost his teeth, the jaws loose their relative vertical, horizontal, and sagittal dimensions. At the same time, the optimum position of the condyle of the mandible in the fossa is lost.

Resulting problems include joint cracking, teeth grinding, migraine headache, or even tinnitus. However, changes of this type can occur already after the loss of a single lateral tooth or even in the event of untreated malocclusion, which can force the jaws into a so-called forced biting position. Even the introduction of fillings or natural tooth abrasion can result in changes and the above-mentioned consequences.

To produce a dental prosthesis according to the state of technology, the attending person first obtains a dental impression of the relevant jaw region. Subsequently a model is created using a casting of the impression. The models are placed in the correct relative position, so that subsequently a preliminary structure can be made available by modeling or CAD. This is subsequently tested in an articulator and at least mean-value-fitted to the particular bite situation. On the basis of the preliminary structure produced and tested in this manner, the dental prosthesis is subsequently produced by e.g. casting, milling, or pressing. This is followed by grinding-in on average and in vivo. The final incorporation takes place after possibly required finishing work.

State of technology methods already attempt—with more or less success—to take into account the stomatognathic system in the production of dental prostheses, i.e. the functional system of the chewing organ, which comprises the skull, muscles, and the physical anatomy. Often however, only snapshots are taken of the operational sequence, i.e. only the final bite position, for example, is documented without taking into consideration the motion of the jaw (System Ivoclar®/Vivadent®).

A system in use under the name “Arcus®” takes into account jaw and muscle motions that are acquired by sensors issuing from facebows. A dental prosthesis is subsequently produced on the basis of the data acquired in this manner. Thus, one takes into consideration data that was acquired outside of the mouth and not at the oral functional location.

A so-called DIR® System uses a direct, internal method of jaw function diagnostics and temporomandibular joint function diagnostics by registering movements, and transmitting and converting the resulting signals to a computer-based system. These data subsequently are transmitted to an articulator, in order to subsequently manufacture a dental prosthesis.

The “zebris JMA” system takes into account muscle movements measured by means of skin-surface electrodes in order to manufacture a dental prosthesis.

In another system (FGP technology) a prerequisite to including functional diagnostics is that the following conditions are given: a natural or refurbished antagonist region, a secured front-canine gliding guidance, a temporomandibular joint without substantial pathological medical history, the absence of balance-side antagonistic contacts, and a secured habitual centered position, i.e. requirements that are frequently not met.

It is the objective of the present invention to further develop a method of the above-mentioned type in such a way that a functional prosthesis is produced by incorporation of a preliminary structure, whereby a functional analysis of the stomatognathic system is taken into account.

To meet this objective, the invention intends that the preliminary structure be manufactured from a markable material with a hardness H, which corresponds to 90% to 100% of the hardness of at least a natural or refurbished tooth of the antagonist of the jaw region, that the preliminary structure subsequently integrated into the jaw region remain in the jaw region for a wearing period of approximately 5 to 30 days, that the preliminary structure be subsequently removed and then the functional prosthesis be produced taking into consideration any changes that the preliminary structure underwent during its wearing.

According to the invention, any changes that the preliminary structure, i.e. the temporary provision, undergoes relative to the original condition prior to integration into the jaw are taken into consideration in the manufacture of an improved structure of the final restoration.

The preliminary structure is removed after a wearing period of between 5 and 30 days, in particular between 15 and 20 days, is subsequently measured, e.g. scanned, so that thereupon one can make available a functional prosthesis, in which the functional analysis of the stomatognathic system is taken into account.

The invention makes available a function-analysis system, in which a preliminary structure, which is markable and adaptively abrasive, is integrated into a patient's mouth for a predetermined time period. This means that the preliminary structure—also referred to as temporary functional element—is marked during and by the use. This consequently captures the functional system. In this, the invention creates the possibility of re-working the preliminary structure already during the wearing on the basis of any occurring changes, in order to satisfy the requirements the functional system.

The preliminary structure can consist of at least one material of the group comprising plastic, metal, ceramics, synthetic glass, fiber-reinforced materials, epoxy resin, or other materials suitable for temporary dental prosthetics. The hardness of the preliminary structure should be similar to that of the natural tooth material or less than that of the antagonist.

The final prosthesis is manufactured after removal of the preliminary structure, i.e. after a wearing period of between 5 and 30 days, in particular between 15 and 20 days. This can be carried out using known processes, such as CAD, CAM, or CIM based processes.

For the production of the preliminary structure, the natural dental conditions are ascertained by prior taking of a dental impression, or by scanning of the present situation in the patient's mouth or of a corresponding model. Scanning can be performed intraorally or a dental impression or a model created from a dental impression can be scanned. Ascertainment of the natural dental conditions includes the option of carrying out the ascertainment prior to preparation.

The preliminary structure produced in this manner is then usually at least mean-value fitted by means of an articulator. This can also be performed virtually, i.e. prior to the physical construction of the preliminary structure, the data acquired for the preliminary structure are fitted using a virtual articulator.

The following should be mentioned in regard to the mean-value fitting. A so-called mean-value articulator is used for this purpose. In such a device the mechanical reference variables are set to epidemiologically ascertained average values and are not adjustable. Consequently, an articulator of this type does not offer the full range of adjustments to match the individual conditions of the patient, but rather certain parameters, such as for example the inclination of the joint plane, are fixed by the design and are not individually adjustable. Consequently one is dealing with a mean-value adjustment.

For the manufacture of the functional prosthesis, the function-marking data of the preliminary structure removed from the patient are combined with the data of the jaw region, into which the prosthesis is to be integrated, in order to subsequently produce the functional prosthesis, whereby the functional parameters should again be tested by means of an articulator—possibly virtually as before. The above work steps are performed with the help of software. On the basis of the subsequently available data, known processes such as CAM and CIM are used to produce the definitive, i.e. final prosthetic provision from metal, all-ceramics, plastic, glass-fiber reinforced materials or other materials usually employed for the chosen production process.

Independent thereof, additionally a referencing of the preliminary structure relative to the jaw region into which it is to be integrated should be performed in order to ensure an unambiguous integration of the functional prosthesis. In addition to intraoral referencing options, i.e. those that are performed inside the mouth, which are used to match the data acquired by scanning, it is also possible to carry out an extraoral referencing, i.e. at a model.

The term referencing denotes the correct alignment or the two models (virtual or physical) of the lower and upper jaw relative to each other. Neither a model scan nor an intraoral scan can reveal the positional correspondence of the two jaw halves.

During a so-called check-bite—for which the patient bites into a silicone material—the upper and lower sides of the silicone element record the current profile of the lower and upper jaws with the remaining teeth (bite record). This is used as an aid to correctly align the two models relative to each other in the articulator. This method can also be used for virtual models, in which case instead of the physical bite record, one uses its 3D model, which was obtained by scanning, in the virtual articulator. To obtain an unambiguous bite record, it may be necessary to attach artificial markings to the gums or to the remaining teeth. These reference markers must be applied prior to the check-bite, i.e. during the taking of the dental impression that is used to obtain the negative models of the jaw, so that the markers will also be present in the positive models. A bite record can also be taken after the integration of the temporary functional element and will reflect the realization of its bite surface and its position relative to the surrounding dental complement and opposing dental complement.

The invention is particularly characterized by the fact that corrections may be performed on the preliminary structure during the wearing of the preliminary structure. This is particularly practical with respect to bite corrections or bite elevations. In particular, one may examine the occurring loads, so that in the event of detected anomalies, one can re-work the preliminary structure to modify the loads. Corrections to the preliminary structure during the wearing also include the times when a correction is performed immediately after integration.

Also within the scope of the invention's teaching is the manufacture of a bite splint. Bite splints are inserts such as silicone bars used to detect bite problems.

But preferably the term functional prosthesis denotes a permanent or removable dental prosthesis.

The invention's teachings for producing a functional prosthesis take into account the stomatognathic system of the patient. A biodynamical function analysis is performed. Occlusion and incisor functions, periodontal mobility, bone deformations of the lower jaw, degrees of periodontal loosening, relative jaw positions, and/or muscular effects are registered in accordance with the invention's teaching and absolutely all data affecting the masticatory system are taken into account. Just by wearing the preliminary structure, the patient marks his own occlusion. According to the invention, the functional analysis does not make use of single-instant records but rather a long-term functional analysis is carried out in the mouth itself.

The invention also allows the detection of poor preparation during the manufacturing of the functional prosthesis.

The final functional prosthesis consequently takes into account all diagnostically relevant information.

The invention further relates to a preliminary structure for the manufacture of a functional prosthesis. The preliminary structure is characterized in that it consists of a markable material with a hardness H that corresponds to 90% to 100% of the hardness of at least one natural or refurbished tooth of an antagonist of a jaw region for which the functional prosthesis is intended. Features of the preliminary structure are detailed in the description as well as in the characteristic features of the claims.

Further details, advantages, and features of the invention are not only found in the claims, the characteristic features described therein—on their own and/or in combination, but also in the following description of an embodiment example.

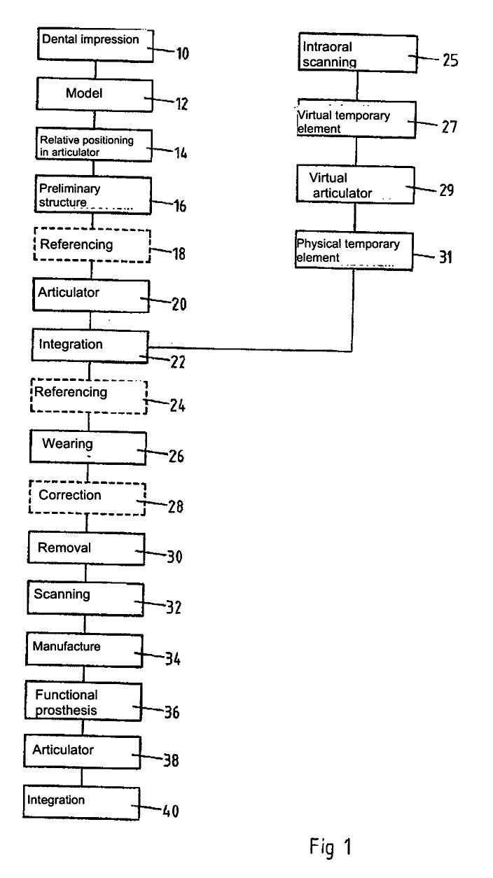

FIG. 1 shows a flow diagram.

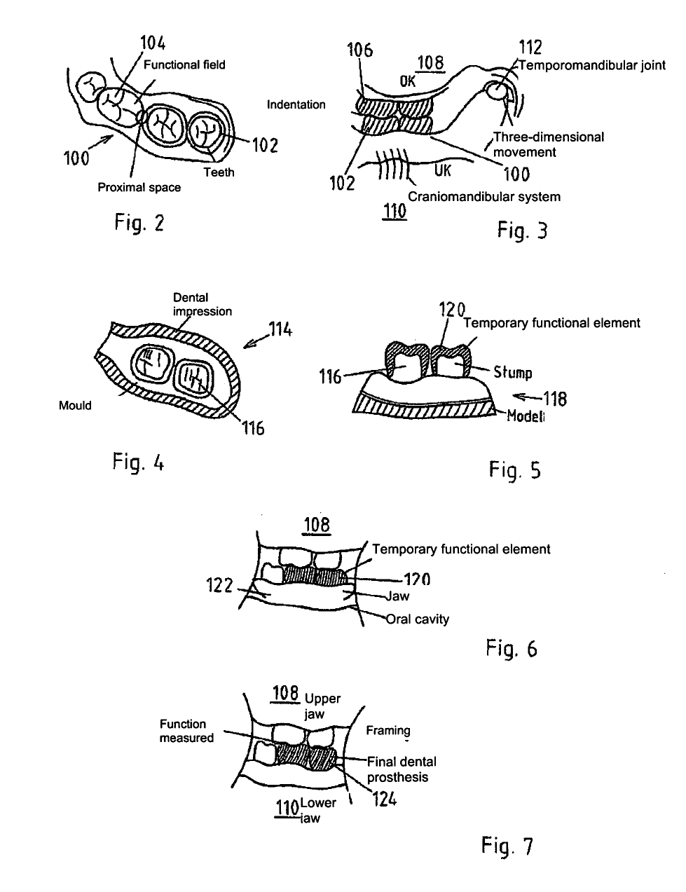

FIG. 2 shows a top view of a dental complement.

FIG. 3 shows a schematic side view of a jaw region.

FIG. 4 shows a dental impression.

FIG. 5 shows a casting of the dental impression with a temporary functional element.

FIG. 6 shows a schematic illustration of an oral cavity with teeth provided with a temporary functional element.

FIG. 7 shows a schematic illustration of a completed, integrated dental prosthesis.

FIG. 1 shows a flow diagram that illustrates the invention's method for manufacture of a functional prosthesis. A crown is used as a functional prosthesis purely as an example, without limiting the scope of the invention's teaching.

In accordance with the left branch of the flow diagram in FIG. 1, one at first creates a dental impression 10, to create a model (procedure step 12). Usually these models are subsequently mounted in correct relative positions in an articulator (procedure step 14), in order to subsequently produce the preliminary structure by modeling or CAD design (procedure step 16).

Subsequently, the preliminary structure is tested in an articulator and mean-value fitted to the particular bite situation (procedure step 20). Thereupon follows the integration of the crown, i.e. of the temporary functional element, into the mouth of the patient (procedure step 22).

The crown (temporary element) itself should be referenced either relative to the model or after integration (procedure step 18, 24).

As an alternative—in accordance with the right branch of the flow diagram—scanning may be performed intraorally (procedure step 25), whereupon one produces a virtual temporary element 27 in a known manner, which is then tested in a virtual articulator (procedure step 29). The temporary element subsequently is produced on the basis of the data made available in this manner (procedure step 31).

After being integrated, the temporary element is worn for a time period of between 5 and 30 days, in particular for 15 to 20 days (procedure step 26). During the wearing, testing of the temporary element and possibly necessary corrections may be carried out (procedure step 28), e.g. in a case where it is found that certain regions of the temporary element are subject to inadmissible or unbalanced loads, in order to subsequently re-work the temporary element to modify the bite.

Subsequently, after the previously designated wearing period, the temporary element is removed (procedure step 30) and scanned (procedure step 32), in order to use known CAM or CIM processes (procedure step 34) to produce the crown (functional prosthesis) (procedure step 36). The crown is then usually placed in the model—possibly a virtual one—and tested in an articulator (procedure step 38), in order to subsequently integrate the possibly corrected crown (procedure step 40).

The method according to the invention will be explained in more detail with the help of FIGS. 2 to 7.

In the production of a functional prosthesis according to the invention, the functional acquisition of the sequence of motions of the jaws and their respective teeth relative to each other is taken into consideration. This ensures that all relevant factors are acquired that are responsible for a problem-free performance of the chewing motions.

FIG. 2 shows a top view of a section of a jaw region 100 with its dental complement (teeth) 102, which in turn possesses functional fields 104. A corresponding region is illustrated in a side view in FIG. 3 in order to illustrate the interlocking between the teeth 102 shown in FIG. 2 and the antagonists 106, which are situated in the upper jaw 108. Upper jaw 108 and lower jaw 110 are joined via a temporomandibular joint 112 that allows three-dimensional movements.

A dental impression is taken of the jaw region 100 in order to obtain a mould 114 of the dental complement 102, which includes stumps 116. A model 118 is produced using the mould 114 to produce a temporary provision, a so-called temporary functional element, which carries the reference label 120.

While FIGS. 4 and 5 illustrate the manual molding and creation of a model, it is also possible to scan the dental complement 102 of the jaw region 100, in order to subsequently produce a reconstruction, i.e. the temporary functional element 120, with the help of CAD software.

The temporary functional element 120, which in FIG. 6 is illustrated as seen from the oral cavity 122, consists of a material that possesses a lower hardness than the natural teeth. In particular, the hardness corresponds to 90% to 100% of the hardness of the associated antagonist(s), be this a natural tooth or a refurbished tooth. Suitable materials are carbon, glass, metal, fiber-reinforced material, epoxy resin, or other materials suitable for the dental prosthesis.

The integrated temporary functional element shown in FIG. 6 subsequently is worn for a time period of 5-30 days, in particular between 15 and 20 days. Testing can be performed during the wearing so that corrections may be performed on the temporary functional element 120. The wearing and the changes imparted to the temporary functional element 120 by the wearing ensure that all relevant operational sequences of the stomatognathic system are detected. These extremely precise measuring results are reproduced as a precise reconstruction of the temporary functional structure in a final dental prosthesis 124 with the help of referencing and CAD processes or other conventional production methods for dental prostheses. This includes all production and manufacturing methods known in the art. After a further test in an articulator or in an external measuring and testing system adapted to the invention's method, the dental prosthesis 124 is integrated, as is purely schematically shown in FIG. 7.

The method according to the invention basically takes into account all measurable influences since the function measurements take place at the location where the actual function is taking place and consequently can be detected. All characteristics present in this region are reliably detected.

1. A method for producing a functional prosthesis as a provision for a jaw region, comprising the steps of:
taking a dental impression of the jaw region to be provided with the functional prosthesis,
producing a preliminary structure, and
producing the functional prosthesis on the basis of the preliminary structure, wherein:
the preliminary structure is produced from a markable material with a hardness H that corresponds to 90% to 100% of the hardness of at least one natural or refurbished tooth of an antagonist of the jaw region, in that the preliminary structure subsequently is integrated into the jaw region and remains in the jaw region for a wearing period of approximately between 5 and 30 days, in that the preliminary structure subsequently is removed and the functional prosthesis is manufactured taking into consideration any changes that the preliminary structure underwent during the wearing.

2. The method of claim 1, wherein during the wearing period the preliminary structure is subjected to testing and is re-worked dependent upon any changes that it underwent.

3. The method of claim 1, wherein in dependence upon the changes that the preliminary structure underwent, one carries out corrections such as functional bite elevation and/or a correction of the relative jaw positions.

4. The method of claim 1, wherein during the wearing of the preliminary structure one examines the occurring loads and in the event that anomalies are detected, the preliminary structure is re-worked to modify the loads.

5. The method of claim 1, wherein the preliminary structure is referenced relative to the jaw.

6. The method of claim 5, wherein the referencing is performed extraorally or intraorally.

7. The method of claim 1, wherein the taking of a dental impression is performed physically.

8. The method of claim 1, wherein a dental impression is obtained by intraoral scanning or scanning of a physical impression of the jaw region.

9. The method of claim 1, wherein the preliminary structure is produced by manual modeling and/or CAD or CIM processes.

10. The method of claim 1, wherein the produced preliminary structure is tested in an articulator.

11. The method of claim 1, wherein the preliminary structure is mean-value fitted in an articulator.

12. The method of claim 1, wherein the functional prosthesis is produced on the basis of the re-worked preliminary structure.

13. The method of claim 1, wherein the functional prosthesis is a permanent or removable dental prosthesis or a bite splint.

14. The method of claim 1, wherein as material for the preliminary structure one uses at least one material from the group comprising plastic, metal, soft synthetic glass, ceramics, epoxy resin, and fiber-reinforced material.

15. The method of claim 1, wherein as material for the functional prosthesis one uses at least one biocompatible material from the group comprising metal, ceramics, plastic, and fiber-reinforced material.

16. A preliminary structure for manufacture of a functional prosthesis, wherein the preliminary structure is produced from a markable material with a hardness H that corresponds to 90% to 100% of the hardness of at least one natural or refurbished tooth of an antagonist of a jaw region for which the functional prosthesis is intended.
